(19) United States
(12) Patent Application Publication
(10) Pub. No.: US 2006/0064300 A1
(43) Pub. Date: Mar. 23, 2006

(54) Audio mixing method and computer software product

(76) Inventor: Aaron M. Holladay, Bloomington, IN (US)

Correspondence Address: BARNES & THORNBURG, LLP, P.O. BOX 2786, CHICAGO, IL, 60690-2786, US

(21) Appl. No.: 11/220,940

(22) Filed: Sep. 7, 2005

Related U.S. Application Data
(60) Provisional application No. 60/608,227, filed on Sep. 9, 2004.

(51) Int. Cl. G10L 19/14

(52) U.S. Cl. 704/224

(57) ABSTRACT

Disclosed is a computer software product, method, and system for audio mixing. The disclosed method represents a sound track as an icon a virtual stage. Characteristics of the sound track are controlled based on the positioning of the icon on the virtual stage. One or more tracks may be mixed simultaneously by selecting a path for an icon to follow. Characteristics may include volume, pan, or other distribution among channels, speakers, or other output devices.

### RELATED APPLICATION

This application claims the benefit of U.S. Provisional Application No. 60/608,227 filed Sep. 9, 2004, the disclosure of which is hereby incorporated by reference in its entirety.

### BACKGROUND

The present disclosure relates to a music development methods and computer software. Methods of mixing various music tracks are well known in the art. One known system allows a user to add tracks to a song using a timeline interface in which the track will play at a desired time within the song. Multiple tracks are selected, positioned along the time line, and then saved or edited within the song. Settings for each track and/or each time position can be adjusted. Setting may include balance, volume, reverberation, and other settings.

The interface for assigning and controlling settings for tracks or other portions of a song or sound track during development has to this point been fairly complex, requiring detailed interfaces which may crowd the screen during sound development. It is desirable to have a simple interface to control settings for one or more tracks that allows easy manipulation of such settings, even by those with no or little experience creating music.

Briefly, in accordance with the foregoing, disclosed is a method, computer program product, and system for audio mixing that uses a spatial relationship of an icon representing a track to control a sound setting for an audio track during song development. A virtual stage is provided on which icons representing sound tracks can be placed. The position of the icon on the stage controls at least one setting for the track. A series of positions may be assigned for each icon controlling the settings of the track as the song is played. An icon may change size, shape, or other characteristic as the icon progresses along the series of positions to indicate a settings change.

Additional features and embodiments will become apparent to those skilled in the art upon consideration of the following detailed description of drawings.

### BRIEF DESCRIPTION OF THE DRAWINGS

The present disclosure will be described hereafter with reference to the attached drawings which are given as a non-limiting example only, in which:

FIG. 1 is a screenshot of an interface for position-based audio mixing;

FIG. 2 is a screenshot of the interface of FIG. 1 with an add track menu activated;

FIG. 3 is a screenshot of the interface of FIG. 1 showing a track icon;

FIG. 4 is a screenshot of the interface of FIG. 1 showing a track icon and a track icon path;

FIG. 5 is a screenshot of the interface of FIG. 4 showing a track icon after progressing through an additional icon path;

FIG. 6 is a screenshot of the interface of FIG. 5 showing a second track icon and a path for the second track icon;

FIG. 7 is a simplified diagrammatic representation of an audio mixing interface;

FIG. 8 is a simplified diagrammatic representation of stereo embodiment of a virtual stage;

FIG. 9 is a simplified diagrammatic representation of a surround sound embodiment of a virtual stage;

FIG. 10 is simplified diagrammatic view of a timeline interface;

FIG. 11 is a detailed screenshot of a timeline interface;

FIG. 12 is an audio mixing interface including a virtual stage for surround sound audio mixing;

FIG. 13 is the interface of FIG. 12 showing advanced control options; and

FIG. 14 is the interface of FIG. 12 showing use of multiple tracks.

The exemplification set out herein illustrates embodiments of the disclosure that is not to be construed as limiting the scope of the disclosure in any manner.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to be exhaustive or to limit the disclosure to the details of construction and the arrangements of components set forth in the following description or illustrated in the drawings.

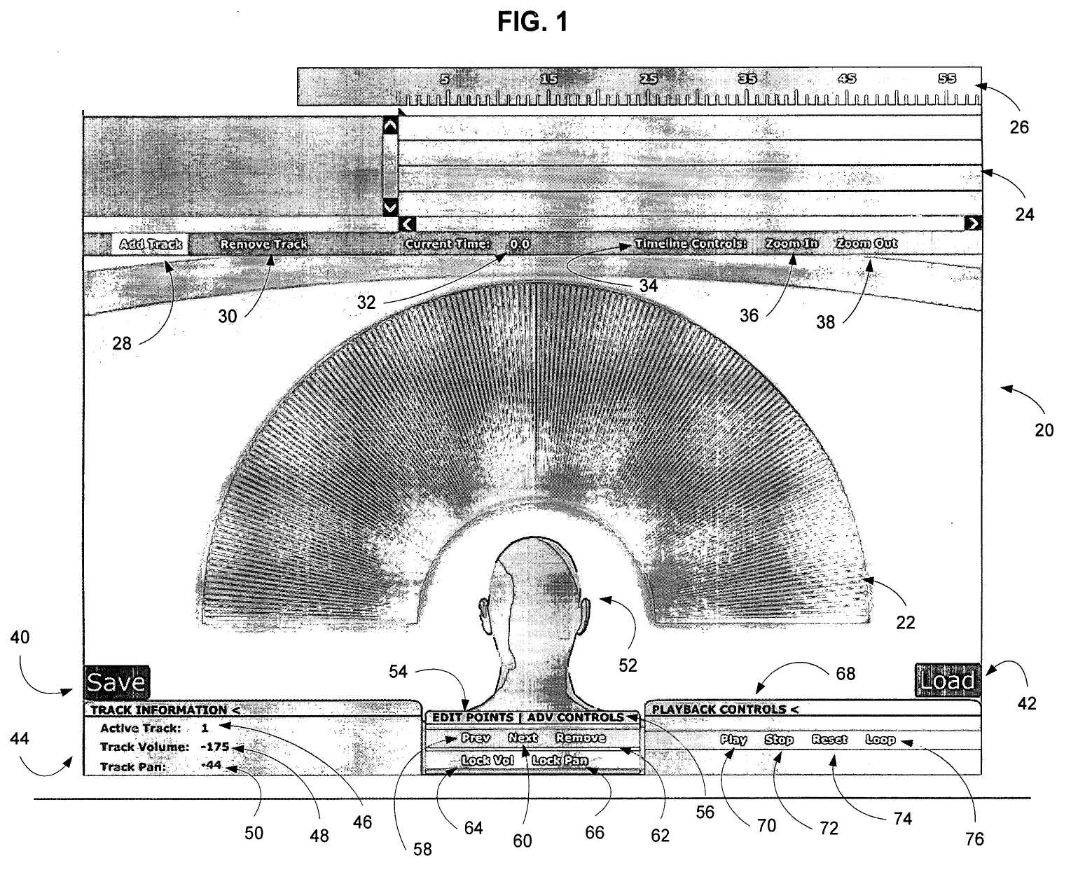

FIG. 1 shows a mixing interface 20 that includes a virtual stage 22 and timeline section 24. Timeline section 24 may include timeline indicia 26 which may take the form of increments of a selected number of seconds, such as five or ten seconds as shown in FIG. 1 or other time indication. The relative size of timeline section 24 and stage 22 may be any proportion, or may be on separate screen that a user can toggle between or otherwise manipulate. Timeline section 24 is used to gauge the progress of the complete song. Although the word “song” is used to refer to one complete audio compilation of one or more tracks, it should be understood that any audio mix can be developed using the interface 20, including, by way of example, but not limitation, a sound clip, song, special effect, compilation of sounds, compilation of songs, and other audio mixes.

Interface 20 will also include a number of menu selections including an add track selection 28 and remove track selection 30. These selections 28, 30 activate a pop-up menu to add or remove tracks from interface 20. A current time indicator 32 may be shown to indicate the current time and will change as a song or track is played. Timeline controls 34 may also be displayed to zoom in 36 or zoom out 38 timeline 24.

Interface 20 may also include a save button 40 or load button 42 for saving or loading the song being developed in finished or unfinished form. A track information section 44 may also be included to provide information about a currently selected track including an active track number 46, the relative track volume 48, and a track pan value 50. Track volume 48 and track pan value 50 are shown as having a numerical indicator. Generally, a higher numerical indicator for volume indicates a higher volume, although other relationships can be used. Although a numeric indicator is shown, other symbols may be used as well, including, by way of example, but not limitation, letters, bars, or a graphical representation such as an oscilloscope. Track pan value 50 may take any form to indicate left channel versus right channel sound distribution. Although a pan value for left and right stereo channels is shown, interface 20 may be used for additional channels, including but not limited to surround sound channels, 5.1 and 6.1 channel songs, DVD audio, SCD audio, and other multi-channel formats.

Interface 20 also includes an avatar 52 which may be any graphical representation of a designation point of interface 20 from which track coordinates, or relative positioning, may be determined. Avatar 52 is shown in the form of a bald human head although any other graphic may be used. Avatar 52 may also be positioned at other locations around stage 22.

An edit points selection 54 activates one or more edit point controls that can be used to manipulate edit points. An advanced controls selection 56 can similarly be used to display a menu of advanced controls. Edit point controls include a previous or “prev” selection 58 and a next selection 60 which allows toggling between multiple edit points. A remove selection 62 allows a particular edit point to be removed. A lock volume selection 64 and lock pan selection 66 cause a selected icon to have its volume and pan settings respectively locked. Playback controls 68 include standard controls for playing tracks and/or songs, including a play button 70, stop button 72, reset button 74, and loop button 76.

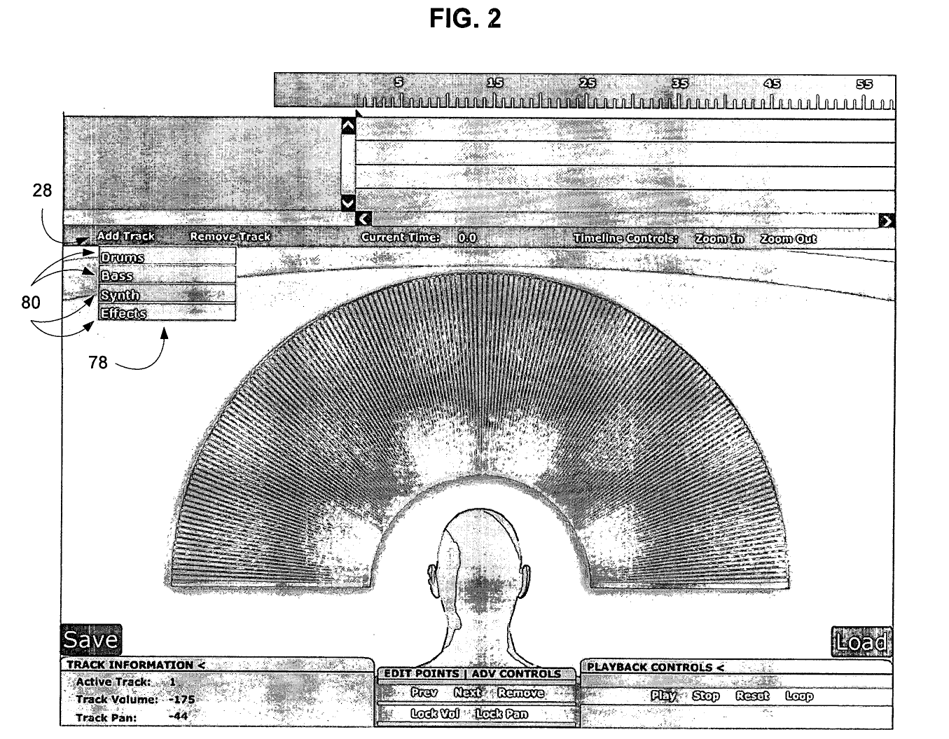

Interface 20 is used as follows. As shown in FIG. 2, the add track selection 28 may be selected to activate add track menu 78. One or more menu items 80 may be displayed to correspond to different types of tracks, such as different layers of a song including vocal, drums, bass, synth, instrumental, and effects, although any number of categories of music may be displayed depending on the application of the music or sounds being developed. Menu 78 may cause other dialog boxes to be displayed, such a sublevels or subcategories of tracks, or to display a file browser dialog to select a particular track file. Any format of music file may be used via interface 20, including .wav files and .mp3 files.

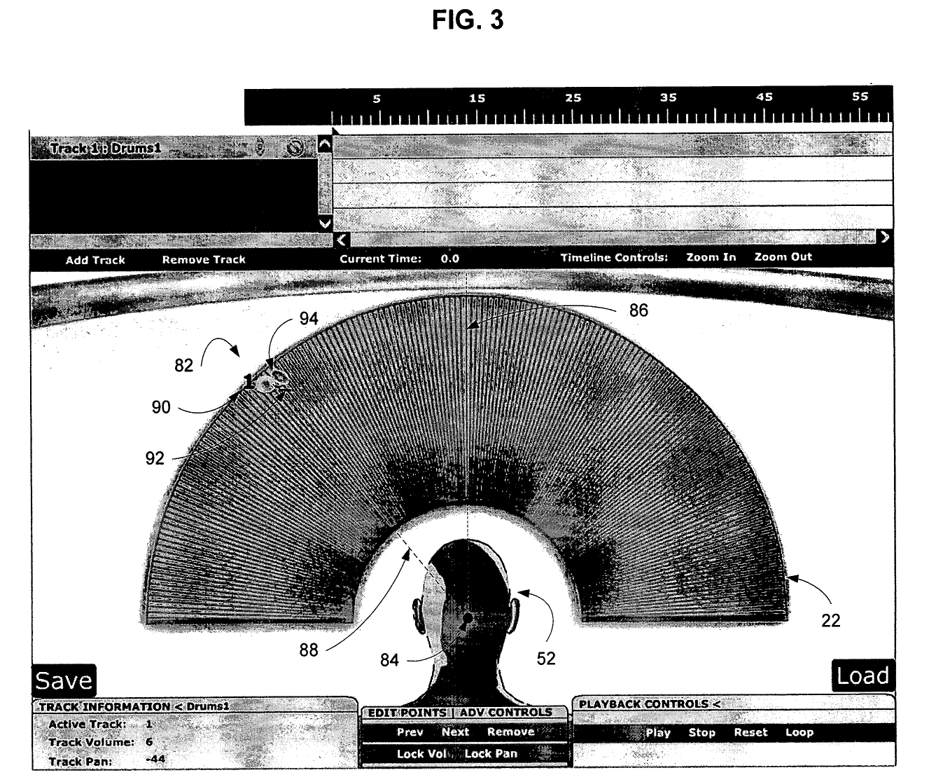

As shown in FIG. 3, a selected track is displayed on stage 22 as an icon 82. Icon 82 may have several designations to identify icon 82, including a track number 90, track label 92, and track graphic 94. Track graphic 94 may correspond to the category of track, for example, a trumpet may be shown for a trumpet track, or drums for a percussion track, and generally makes viewing the track icon more fun. Settings for track icon 82 are based on the position of track icon 82 in relation to origin 84 and avatar axis 86. Origin 84 is shown to be generally in the center of avatar's head graphic 52 although other positions may be used. Axis 86 may extend generally vertically from origin 84.

Settings for the track represented by track icon 82 are determined by the track icon's position relative to origin 84 and axis 86. A distance 88 from origin 84 will control the relative track volume, meaning an icon 82 placed closer will play at a louder volume and an icon 84 placed farther will play a relatively quieter volume. The designation of farther—quieter and closer—louder may be reversed as well.

The pan setting for the track represented by track icon 82 will generally depend on the distance away from axis 86. An icon 82 placed directly on axis 86 may cause the pan setting to have an equal or balanced distribution to the left and right channels. A track icon 82 that is farther to the left, such as the icon 82 shown in FIG. 3, would distribute a greater percentage of the volume to the left channel than the right channel. The relative distribution may be based on the perpendicular distance to axis 86, or may be based on the angle of line 88 relative to axis 86, or some other measure based on stage placement.

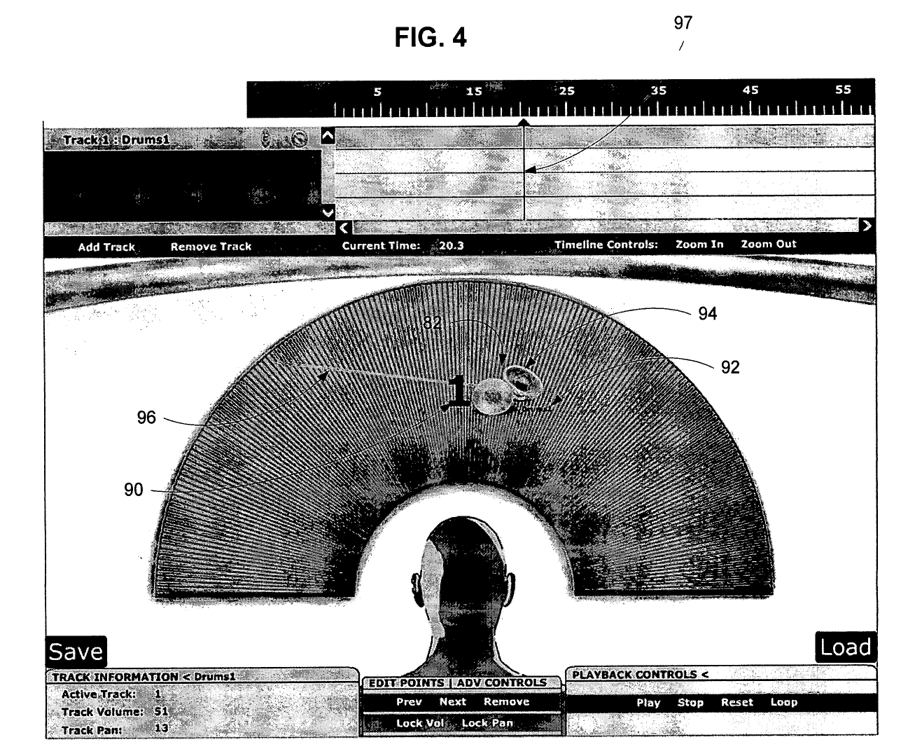

As shown in FIG. 4, a user may define a path 96 for icon 82 to follow. Icon 82 will travel along path 96 at a generally steady rate allowing the user to control how long the track will play in the song. A selected position in timeline 24 can be selected for the path so that a user can select when the track will play and exactly how long the selected track will play for. The starting point is shown as a vertical line 97, but may also be shown as a highlighted region within timeline 24. As icon 82 travels along path 96, because the distance to the origin 84 and avatar axis 86 are not held constant, the volume and pan settings will change accordingly. Thus the user is able to graphically, based on the position of icon 82 on stage 22, change track settings while the track is playing. This simple, graphical technique has advantages in that no complex controls are needed, and both advanced and novice users maintain a large measure of control easily.

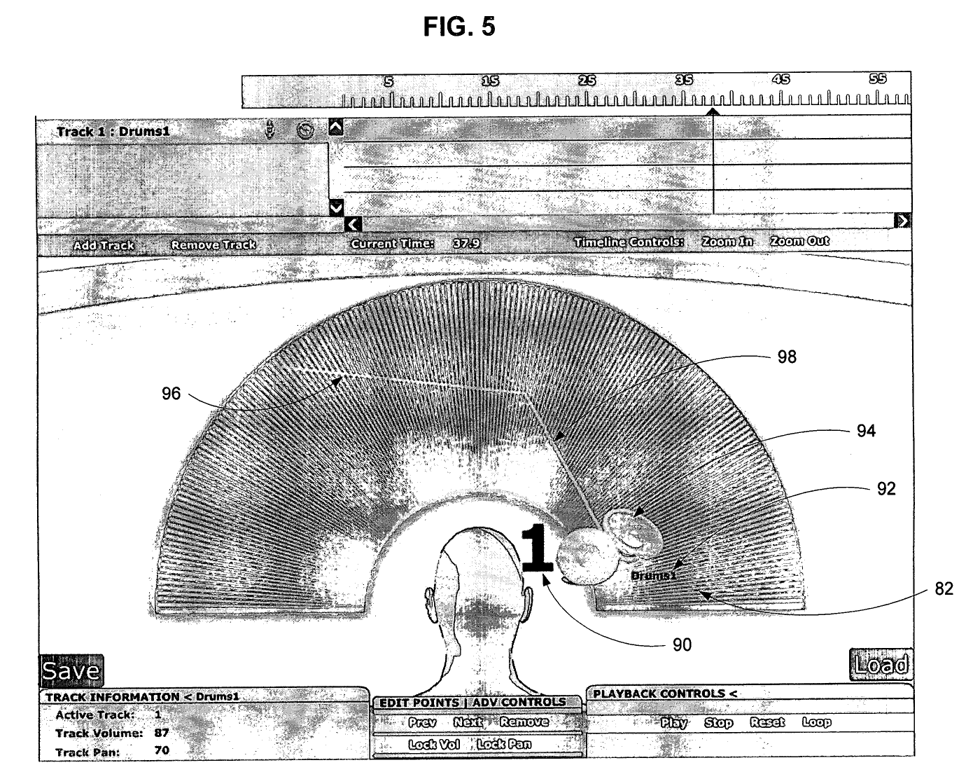

As icon 82 is directed closer to origin 84, track number 90, graphic 94, and label 92, may also become larger to in yet another fashion, indicate the volume setting for the selected track is increasing. As shown in FIG. 5, after icon 82 has been directed to move closer to origin 84 along a second path 98, the dimensions of the icon 82 components have become larger.

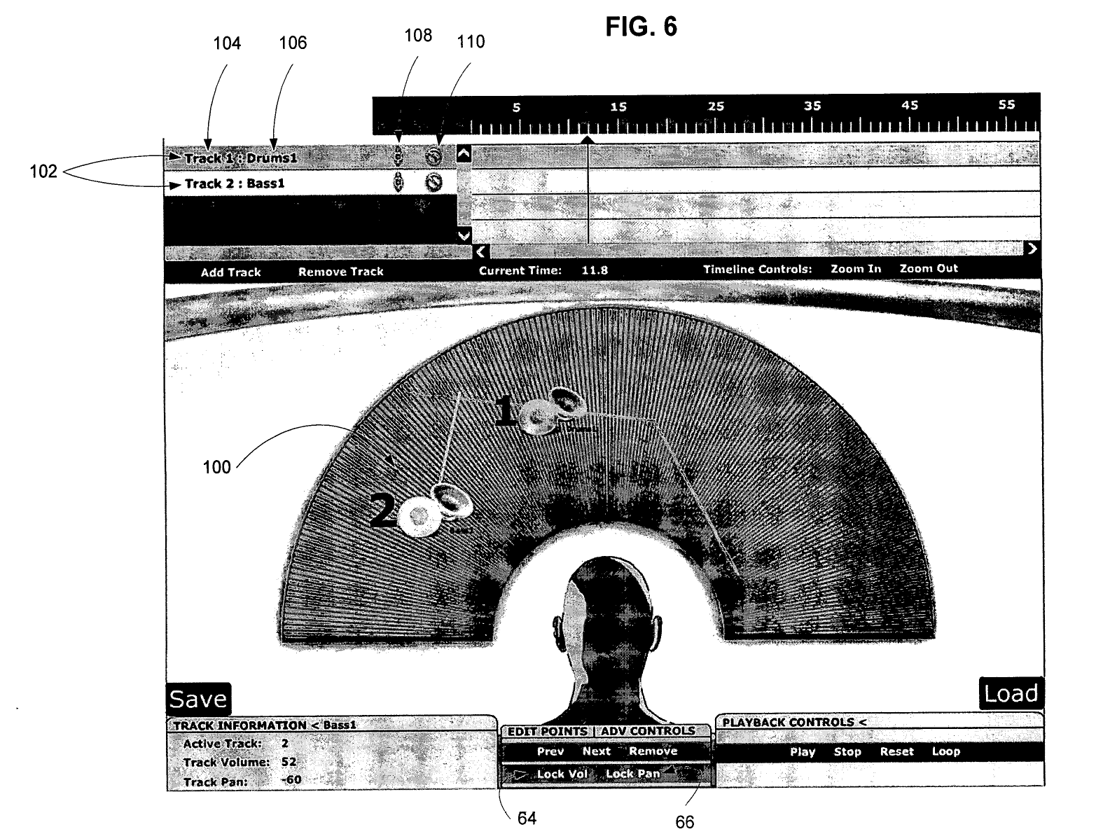

As shown in FIG. 6, a second track can be added as depicted by second icon 100. In this manner, multiple tracks can play simultaneously or otherwise overlap over the course of the song and have separate paths while the tracks are playing. As each icon follows a different path, the related track will have a different progression of volume and pan settings. Each track will also have track information 102 shown on the interface 20 which includes a track number 104 and track name 106. A microphone icon or the like 108 can be clicked to lock the volume for the selected track, meaning the path will maintain a constant distance from origin 84. A mute control 110 is also provided to allow a track to be muted while the song is played. The lock pan 66 selection can also be depressed to lock the pan, meaning, for example, the track path can only be vertical. Paths may have any number or edit points. Any number of tracks may be added to a single song, although if more than 4 tracks are implemented, timeline 24 may be expanded accordingly.

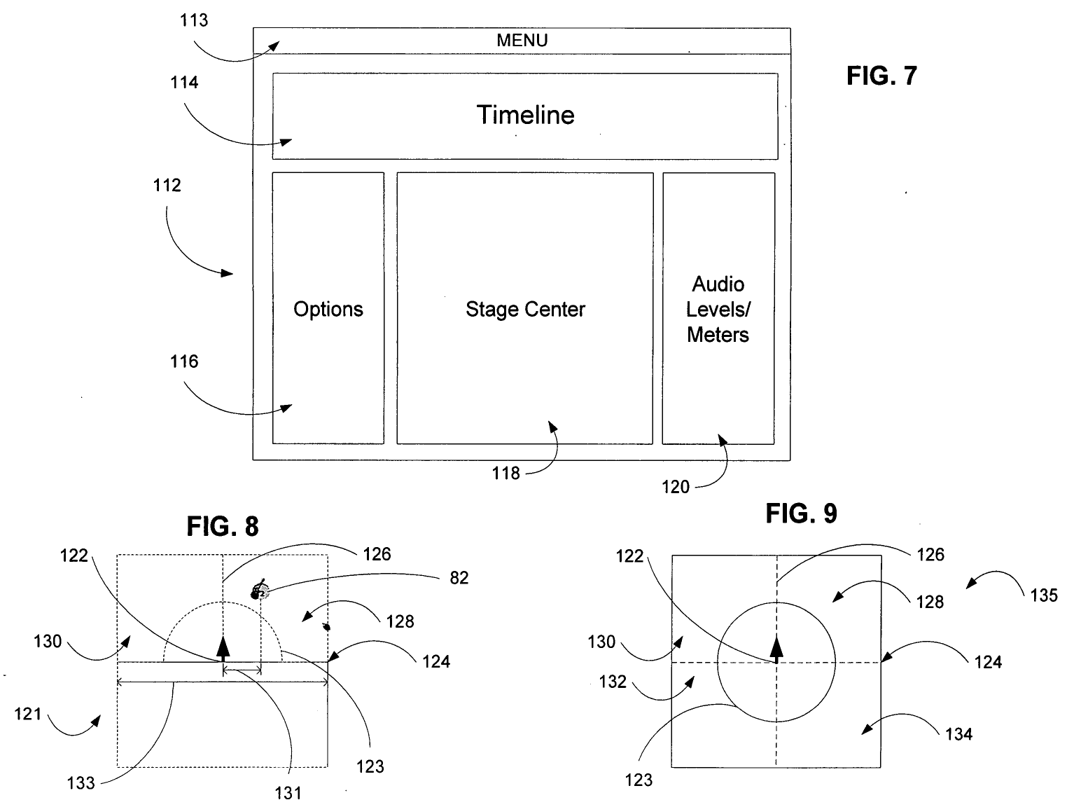

An alternative embodiment of an audio mixing interface is shown in FIG. 7. Interface 112 may include a menu portion 113, timeline portion 114, options portion 116, stage center 118, and audio level controls and meters section 120. Menu portion 113 may include menu structures known in the art, which may include options corresponding to a particular task being performed, including by way of example, but not limitation, file access, options, sound card settings, interface customization settings, and other items.

FIG. 8 shows an example of stereo stage center 121 which include a centrally located designation point 122 and horizontal axis 124 and vertical axis 126 extending perpendicularly from designation point 122. Axes 124, 126 define a right channel region 128 and left channel region 130, on which icons may be positioned. A reference circumference 123 is provided to show a relative distance from designation point 122 and be marked with indicia, for example +6 db, to show users a relative volume for icons place on, inside, or outside of circumference 123. For example, in an embodiment where positioning an icon closer to designation point 122 corresponding to a louder volume, positioning an icon inside circumference 123 would be louder than +6 db, on circumference 123 would be at +6 db, and outside circumference 123 would be softer than +6 db.

Distribution of a sound among the speakers corresponding to the icon may be based on the relative position of the icon within two regions 128, 130. Generally, the distribution is based on the right-left, or x-axis component 131 of the icon's position. The actual distribution may be calculated a number of different ways, including for example, using a ratio of the x-component to the total distance 133 between endpoints of horizontal axis 124. For example, if total distance 133 is 100 units, and the x-component is 25 units, the following formula may be used: 1−(x component/total distance); substituting: 1−(25/100)=75% distribution to the right channel. The remaining distribution would then be allocated the other channel, the left channel. The above distribution calculation is shown by way of non-limiting example only.

FIG. 9 shows a surround sound embodiment 135 of stage center 118. Axes 124, 126 extend to define two additional regions, a rear left region 132, and rear right region 134. Each region would correspond to a distribution to a speaker channel. Thus, the embodiment 135 adds the ability to control four speakers rather than two, and control pan forward and backward in addition to right and left.

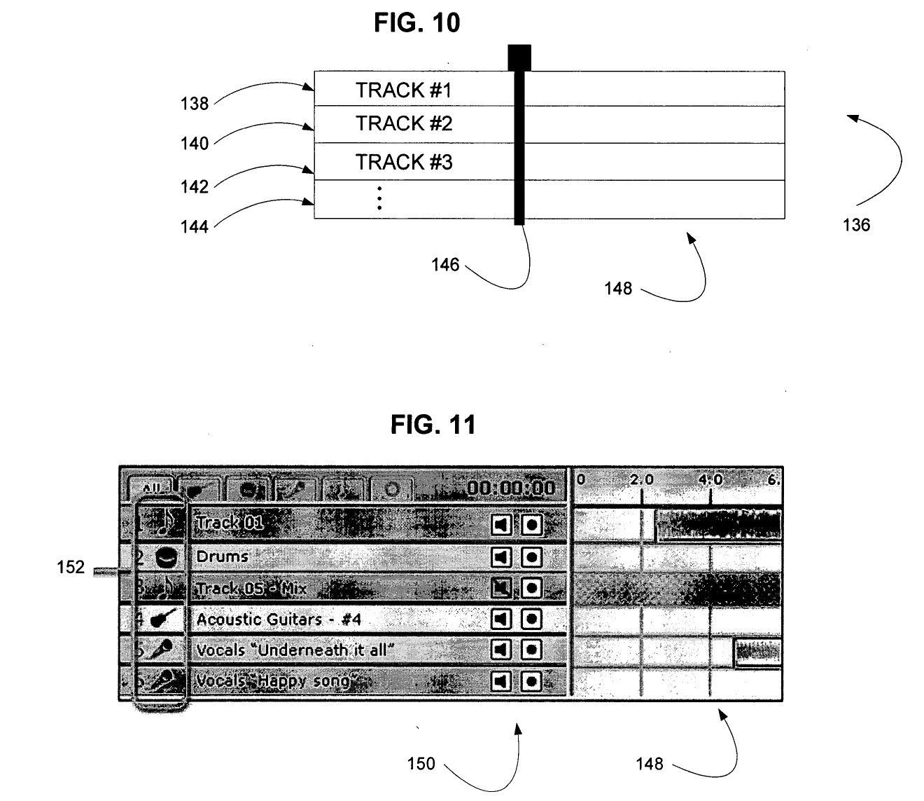

FIG. 10 shows an embodiment of a timeline portion 136 in which 3 tracks have been loaded. Track 1 138, track 2 140, and track 3 142 may be selected to play over any portion of the entire song or compilation, with the pan, volume, and other settings of a particular track controlled by positioning and path on the virtual stage. Additional tracks or layers may be added by clicking or otherwise selecting inside area 144. When played, a tracking bar 146 may slide toward the right over a tracking area 148 to indicate a relative time. Time indicia, such as seconds, minutes, or partial seconds (not shown) may be used as well.

Another embodiment of the timeline interface 148 is shown in FIG. 11. Each track may be assigned a symbol, icon, or other indicia 152. The same or similar indicia may be used as the icon 82 on the virtual stage.

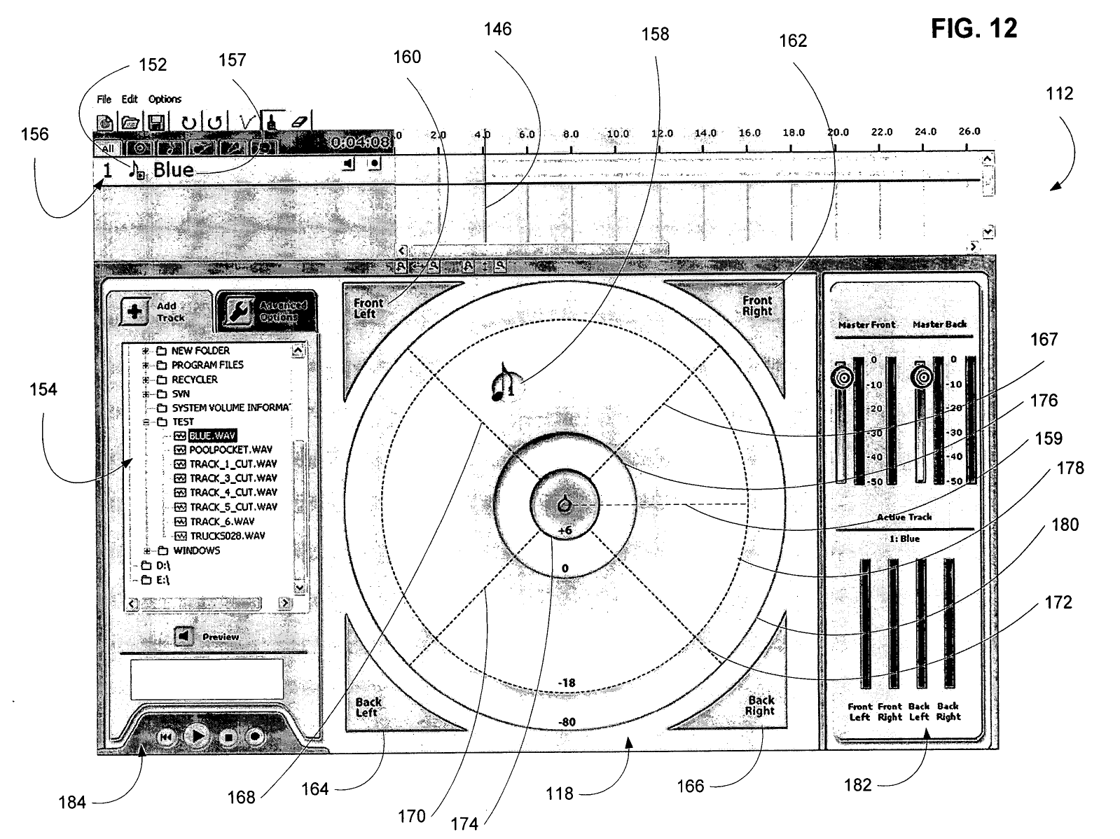

FIG. 12 shows another embodiment of audio mixing interface 112. Interface 112 includes a file tree file selection window 154 for selecting tracks to be added to the mixing software. Although a file tree is shown, other file organizations, menus, or other file selection interfaces may be used. A selected file is shown in the upper portion of the interface by its track number 156, symbol 152, and track name 157. A selected track also appears as an icon 158 on stage center 118. Designations may be shown for the speaker channels controlled by the interface including but not limited to a front left designation 160, a front right designation 162, a back left designation 164, and a back right designation 166.

A plurality of speaker radii may be used to guide a user on where to position an icon to achieve a desired distribution. In one embodiment, positioning an icon directly on a speaker radius means that the sound will be distributed solely to that speaker. For convenience, the positioning of the radii is discussed with respect to a polar coordinate system described in degrees from a reference line 159. A polar coordinate system and the units of degrees are used for illustrative purposes only. Any combination of positioning systems and units, including but not limited to a Cartesian coordinate system and use of radians as units of measure, may be used as well.

A first radius 167 corresponding to front right designation 162 may be positioned 45 degrees relative to line 159. A second radius 168, a third radius 170, and a fourth radius 172 corresponding to front left designation 160, back left designation 164, and back right designation 166, respectively, may be positioned at intervals of 90 degrees from first radius 166. Thus an exemplary position of the four radii would be at 45 degrees, 135 degrees, 225 degrees, and 315 degrees, relative to line 159. As an example, in use, an icon positioned between first radius 167 and second radius 168 would have some distribution between the two front speakers channels. In another example, an icon positioned between first radius 167 and fourth radius 172 would have some distribution between the front right and rear right speaker channels. Numerous combinations could thus be achieved. It is envisioned that the center may also be expanded to allow a wider area for icons to occupy to allow distribution among all four channels.

A reference circumference 174 is shown with reference to a selected volume, for example +6 db. Additional reference circumferences 176, 178, 180 may be used as well, having exemplary volume vales of 0, −18 db, and −80 db.

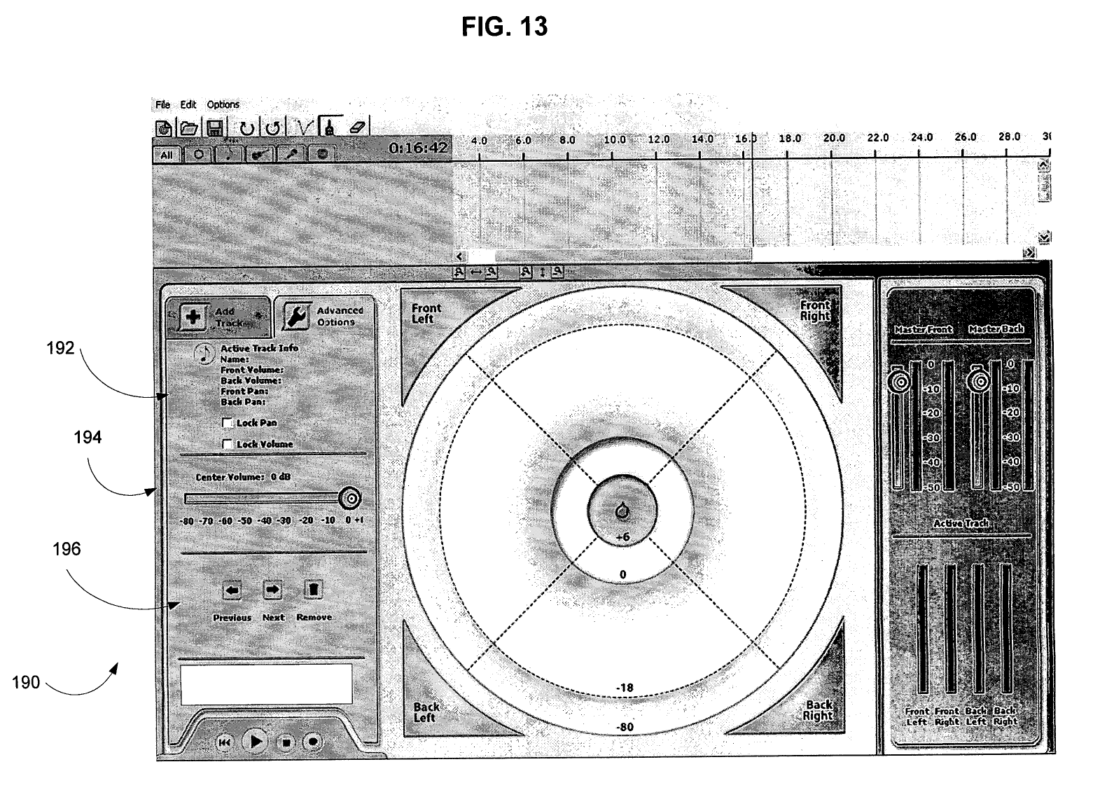

FIG. 13 shows an advanced option tab 190 that has been selected in place of file selection interface. Controls may include lock pan or volume controls 192, center channel volume 194, track selection and deletion controls 196, and other controls.

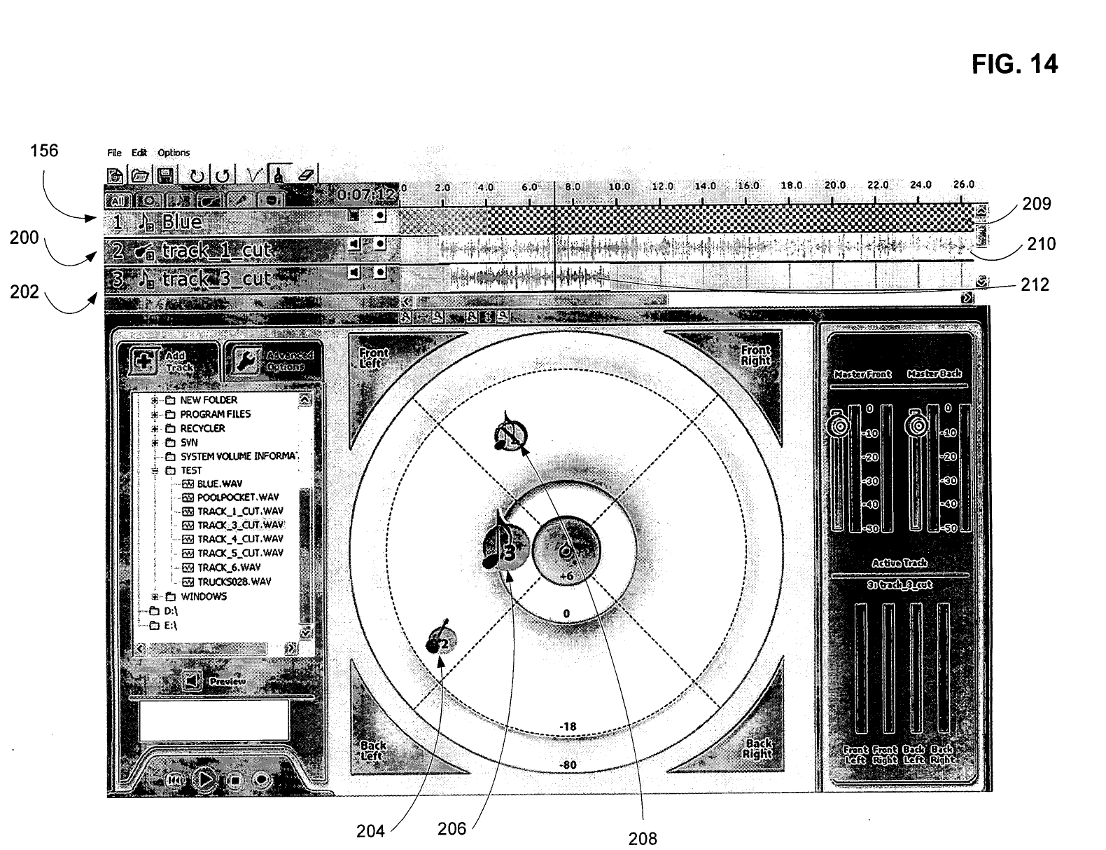

FIG. 14 shows an addition of two tracks 200, 202. Each of the tracks 156, 200, and 202 includes corresponding oscilloscope portions 209, 210, 212 which show frequency information along with what portion of the total song a particular track occupies. Each track also has an icon representation that for convenient reference may include the same symbol shown adjacent to the track name. For example, track one has a note symbol so is shown as note icon 208. Track 200 is shown with a guitar symbol so is shown as a guitar icon 204 and track 202 is shown with a note symbol so appears as a note icon 206. Controls for muting a particular track, as discussed above, may be used which would result in a mute symbol being superimposed on an icon as shown for icon 208.

One or more software modules operative to, when loaded on a computing device, provide the functionality described above may also be loaded onto a computer readable media, such as a CD-ROM, floppy disc, DVD, other storage media, or other computer program product. The software modules may also be made available as a file download or operate as a plug-in to a browser, or be delivered as a web-based or ASP application. The software module may also be written or delivered via the Flash product from Macromedia, Inc. The term “computer module” or “software module” referenced in this disclosure is meant to be broadly interpreted and cover various types of software code including but not limited to routines, functions, objects, libraries, classes, members, packages, procedures, methods, or lines of code together performing similar functionality to these types of coding. The components of the present disclosure are described herein in terms of functional block components, flow charts and various processing steps. As such, it should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, the software elements of the present disclosure may be implemented with any programming or scripting language such as C, SQL, C++, Java, COBOL, assembler, PERL, or the like, with the various algorithms being implemented with any combination of data structures, objects, processes, routines or other programming elements. Further, it should be noted that the present disclosure may employ any number of conventional techniques for data transmission, signaling, data processing, network control, and the like as well as those yet to be conceived.

While this disclosure has been described as having exemplary embodiments, this application is intended to cover any variations, uses, or adaptations using the general principles set forth herein. It is envisioned that those skilled in the art may devise various modifications and equivalents without departing from the spirit and scope of the disclosure as recited in the following claims. Further, this application is intended to cover such departures from the present disclosure as come within the known or customary practice within the art to which it pertains.

1. A computer-assisted method of audio mixing, the method comprising the steps of:
providing a mixing interface, the mixing interface including a virtual stage interface;
representing a sound track as an icon;
positioning the icon on the virtual stage; and
controlling at least one characteristic of the sound track based on a position of the icon on the virtual stage.

2. The method of claim 1, further comprising the mixing interface including a timeline, the timeline corresponding to a full song.

3. The method of claim 2, further comprising assigning the sound track to at least a portion of the timeline.

4. The method of claim 1, wherein the at least one characteristic is volume.

5. The method of claim 4, further comprising providing a designation point on the virtual stage and controlling the volume by setting the volume louder when the icon is positioned closer to the designation point and softer when positioned the icon is farther from the designation point.

6. The method of claim 5, further comprising increasing the size of the icon as the volume becomes louder and reducing the size of the icon as the volume becomes softer.

7. The method of claim 1, wherein the at least one characteristic is a pan setting.

8. The method of claim 7, further comprising:
providing a designation point on the virtual stage;
defining a first axis extending transversely through the designation point;
designating a first channel as being in a first direction along the first axis from the designation point;
designating a second channel as being in a second direction along the first axis from the designation point, the second direction being opposite the first direction;
defining a second axis extending through the designation point, the second axis being parallel to the first axis.
controlling the pan by distributing a sound corresponding to the sound track more to the first channel when the sound track is positioned in the first direction from the second axis and more to the second channel when the sound track is positioned in the second direction from the second axis.

9. The method of claim 8, further comprising distributing the sound proportionally among the first channel and second channel based on the proportion of an x-component distance from the designation point to the sound-track.

10. The method of claim 9, further comprising:
providing a first end point and a second end point, the first and second end points being positioned equidistantly along the first axis from the designation point;
defining a full range distance as the distance between the first end point and the second end point;
where the icon is positioned in the first direction, distributing a percentage of the sound to the first channel using the ratio: 1−(the x-component distance divided by the full range distance) and distributing the remaining percentage to the second channel; and
where the icon is positioned in the second direction, distributing the percentage to the second channel using the ratio 1−(the x-component distance divided by the full range distance), and distributing the remaining percentage to the first channel.

11. The method of claim 7, wherein the mixing interface is used to control stereo sound settings.

12. The method of claim 7, further comprising the mixing interface being adapted to control surround sound settings.

13. The method of claim 12, further comprising the surround sound settings including controlling a distribution of sound to one or more of a front right speaker channel, a front left speaker channel, a rear right speaker channel, and a rear left speaker channel.

14. The method of claim 13, further comprising:
providing a designation point on the virtual stage, the virtual stage being circular and the designation point being positioned at a center of the circle;
defining a polar coordinate system onto the virtual stage, the designation point being an origin, and a defining a fixed reference line, the fixed reference line extending from the origin;
defining a plurality of radii, the plurality of radii including a front right speaker radius, the front right speaker radius extending from the origin 45 degrees relative to the fixed reference line, a front left speaker radius, the front left speaker radius extending from the origin 135 degrees relative to the fixed reference line, a rear left speaker radius, the rear right speaker radius extending from the origin 225 degrees relative to the fixed reference line, rear right speaker radius, the rear right speaker radius extending from the origin 315 degrees relative to the fixed reference line; and
distributing the sound corresponding to the icon proportionally among the front right speaker channel, the front left speaker channel, the rear right speaker channel, and the rear left speaker channel based on the position of the icon relative to the plurality of radii.

15. The method of claim 1, further comprising providing a track selection interface for selecting tracks to add to the virtual stage.

16. The method of claim 15, further comprising selecting a track, assigning an icon to the track, and allowing a user to select a first position on the virtual stage for the track.

17. The method of claim 16, further comprising allowing the user to define at least one additional position on the virtual stage to develop a path, the path defined as beginning with the first position and extending to each selected additional position.

18. The method of claim 17, further comprising selecting additional tracks and developing additional paths to mix an audio sample using a combination of the sound track and the additional tracks.

19. The method of claim 15, further comprising the track corresponding to one or more of a drum layer, vocal layer, bass layer, synth layer, instrumental layer, and effects layer.

20. A computer readable medium having program code stored thereon and being for audio mixing, the program code, when executed on a computer, causing the computer to:
provide a mixing interface, the mixing interface including a virtual stage interface;
represent a sound track as an icon;
allow a user to position the icon on the virtual stage; and
allow the user to control at least one characteristic of the sound track based on a position of the icon on the virtual stage.

21. A computerized system for audio mixing:
a general purpose computer operated by a software module operative to:
provide a mixing interface, the mixing interface including a virtual stage interface;
represent a sound track as an icon;
allow a user to position the icon on the virtual stage; and
allow the user to control at least one characteristic of the sound track based on a position of the icon on the virtual stage.
